(19) United States
(12) Patent Application Publication
(10) Pub. No.: US 2008/0126792 A1
(43) Pub. Date: May 29, 2008

(54) Systems and methods for achieving minimal rebooting during system update operations

(76) Inventors: Daniel E. Herington, Fort Collins, CO (US); John R. Diamant, Fort Collins, CO (US); Ian A. Elliot, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/523,245

(22) Filed: Sep. 19, 2006

(51) Int. Cl. G06F 9/00

(52) U.S. Cl. 713/100

(57) ABSTRACT

A virtual machine (VM) is created using an alternate root disk (DRD) that has complete isolation between the booted system environment (BSE) running on the host operating system and the BSE running on the VM's operating system. The VM's root disk and BSE are separately bootable from the host system's root disk and BSE, thereby allowing for updates and modifications to the VM's root disk and BSE without interference with the host system's root disk and BSE regardless of how many times the updating BSE must be rebooted during the updating procedure. At most a single reboot is required in order to transfer the work in progress from the VM to the host system.

### FIELD OF THE INVENTION

This invention relates to computer systems and more importantly to systems and methods for improving update and reboot operations.

### DESCRIPTION OF RELATED ART

In computer systems, users have an interest in being able to update a system in order to add features, resources or simply to update versions. In most cases, it is desired to perform such updating while the system is running, perhaps with only one reboot, regardless of the complexity of the updating required. However, many update procedures requires several reboot operations, which are time consuming and disruptive when other applications are also being processed concurrently on the computer, especially when the computer or services running on it have high availability requirements.

As presently configured, computer systems have several key components. Among these are a root disk (a.k.a. root file system, root image, or simply, root), on which is stored the non-volatile copy of the operating system (OS). A root disk may by a physical disk, a logical volume, area on a storage area network, etc. The root disk can be part or all of the non-volatile storage of a computer. Computer systems also have a booted system environment (BSE), which includes a running copy of the OS and a set of processes, among which are the application processes. When a system boots up, the OS is started by running the copy stored on the root disk. When the system is updated, those updates are installed on the root disk, such that any time the system boots from the root disk, all installed updates are used.

Computer systems can have alternate copies of their root disk. Each dynamic root disk (DRD, a.k.a. alternate root disk or ARD) is independent of all other root disks, including the currently booted root disk, and each root disk may contain a different OS than on the other root disk. If two root disks initially have identical copies of an OS, changes can be made to one root disk, such that the system will behave differently if booted off one root disk vs. another.

A virtual machine (VM) is a computer system that has no physical hardware. A normal computer system has one or more physical processors, physical memory, one or more physical disks, etc. A VM is a procedure (within the BSE of a host system) that emulates the hardware capabilities of a normal system, including providing virtual processor(s), memory and disk(s) (e.g. one or more root disks). Within the VM is another BSE, which runs on the virtual hardware, including its own root disk. As far as an application process is concerned, there is no difference between being run on a virtual system or a physical system.

### BRIEF SUMMARY OF THE INVENTION

An update procedure having a single reboot operation is constructed using a virtual machine (VM) created using another system's dynamic root disk (DRD), such that there is complete “isolation” between the VM's BSE and the original system's BSE. This isolation extends to applications running on the original system's OS and applications running on the VM's OS. The VM's root disk is separately bootable from the original system's root disk, thereby allowing for updates and modifications to one root disk without interference with the other root disk. Regardless of how many times the updating system must be rebooted during an update procedure, the other system need not reboot (the only exception is if the rebooting system is a host to the other, virtual system). After updating one system, that system can be shut down and the root disk transferred to the other system (i.e. the other system boots from the DRD that was updated). At most a single reboot is required in order to change which root disk (and thus OS) a system boots from.

### BRIEF DESCRIPTION OF THE DRAWINGS

For a more complete understanding of the present invention, reference is now made to the following descriptions taken in conjunction with the accompanying drawings, in which:

FIGS. 1A through 1E show embodiments of a multi-application system having a VM for isolation of applications during the update procedure;

FIG. 2 shows one embodiment of a method for controlling the illustrative embodiments shown in FIGS. 1A-1E; and

FIG. 3 shows one embodiment of a system having a VM booted from the original root disk.

### DETAILED DESCRIPTION

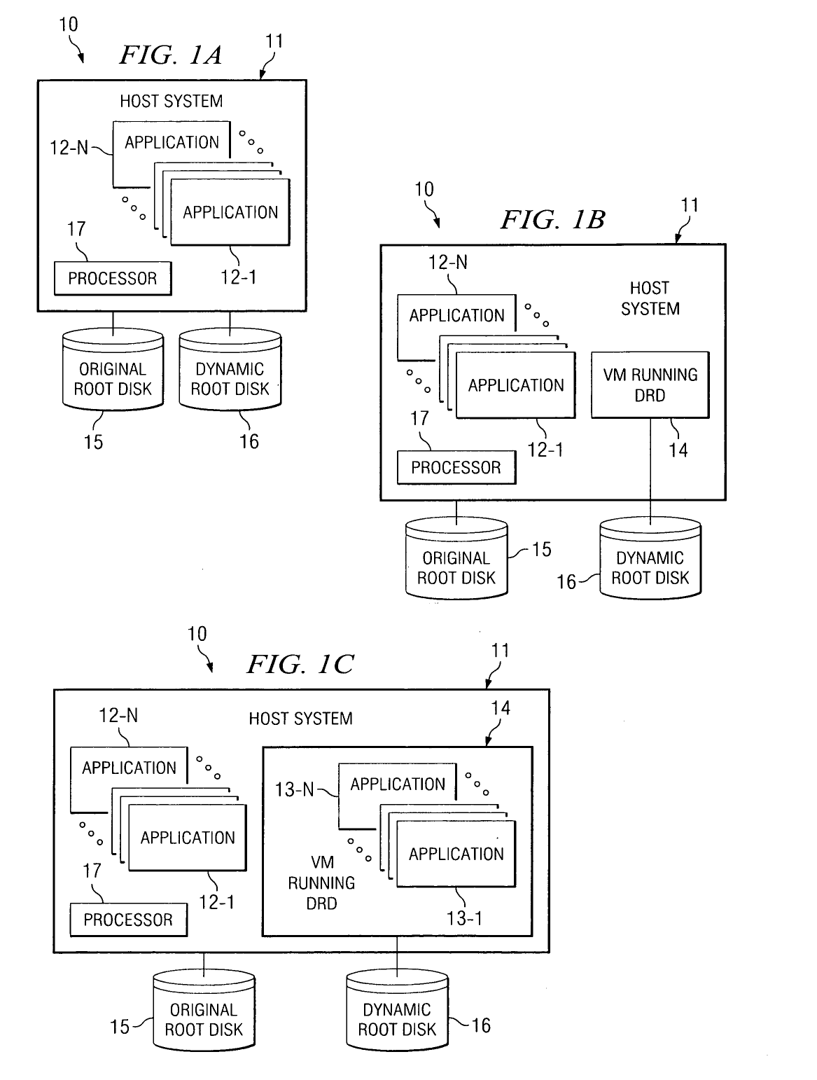

FIG. 1A shows one embodiment 10 of a multi-application (12-1 to 12-N) host system. The host system has a booted system environment (BSE) 11 that is booted from its original root disk (ORD) 15. A copy of ORD 15 is made and becomes dynamic root disk (DRD) 16. As will be seen, DRD 16 can be completely updated while BSE 11 (booted from ORD 15) is running and serving its normal purposes. BSE 11, including applications, platforms, partitions and booting from either ORD or DRD is controlled, at least in part, by one or more processors, such as by processor 17.

FIG. 1B shows the establishment of VM 14 booted from dynamic root disk (DRD) 16, which was copied from the host system's ORD 15. Ownership of DRD 16 was transferred from host system 11 to VM 14, which includes any “personality changes” (e.g. change network identification to that of the VM system) that are needed before the VM system could have been booted from the DRD. The VM's BSE runs while the host system's BSE 11 continues to process applications 12-1 through 12-N. At this point any resource (including applications, operating system, or other computer environment elements) running on the VM system can be updated in VM process 14 without affecting host system's BSE 11 including the running of applications 12-1 through 12-N. All updates are stored on DRD 16 without affecting ORD 15. Testing and rebooting can occur with respect to VM 14 without affecting the host system's BSE 11 and there is no cross-linking of applications between BSE 11 and BSE 14. The applications need not be modified in any manner to have this work.

FIG. 1C shows anew set of applications 13-1 through 13-N (corresponding to the applications 12-1 through 12-N) being run within the VM's BSE 14 after the VM has been updated. This allows the applications to be tested in the updated BSE 14, before these updates are applied to host system 11. If any problems are discovered, the VM's BSE 14 can be further updated. It is also possible, that if the updates are considered unacceptable, the entire VM and its DRD can be destroyed. Again, there is no cross-linking of applications between BSE 11 and BSE 14.

FIG. 1D shows the state of host system 11 after all update and test procedures have occurred but before rebooting from the DRD. Note that VM process 14 has been terminated and ownership of DRD 16 has been transferred back to host system 11. Ownership transfer of the DRD back to the host system 11 includes any “personality changes” (e.g. change network identification to that of the host system) that are needed before the host system can be booted off the DRD.

FIG. 1E shows host system 11 rebooted from DRD 16 instead of from its original root disk 15. Since the DRD contains the stored version of the updates that were performed as discussed above, host system 11 is updated with only one reboot. Applications 12-1 through 12-N are again running, this time on an updated, BSE 11. The user can control which boot disk to boot from. The choice could be a part of starting the system or can be made an explicit choice of the user upon startup. Thus, a user when starting the cloning process, can tell the system to do the whole process, including rebooting with the DRD, or the user can tell the system not to reboot from the DRD. There are interfaces that tell the system firmware what disk to boot from. HP-UX, for example, has the “setboot” command, that says: in the future, boot from disk A, and if disk A is unavailable, boot from disk B. The system and method discussed herein could use setboot on HP-UX. There are other approaches on other operating systems.

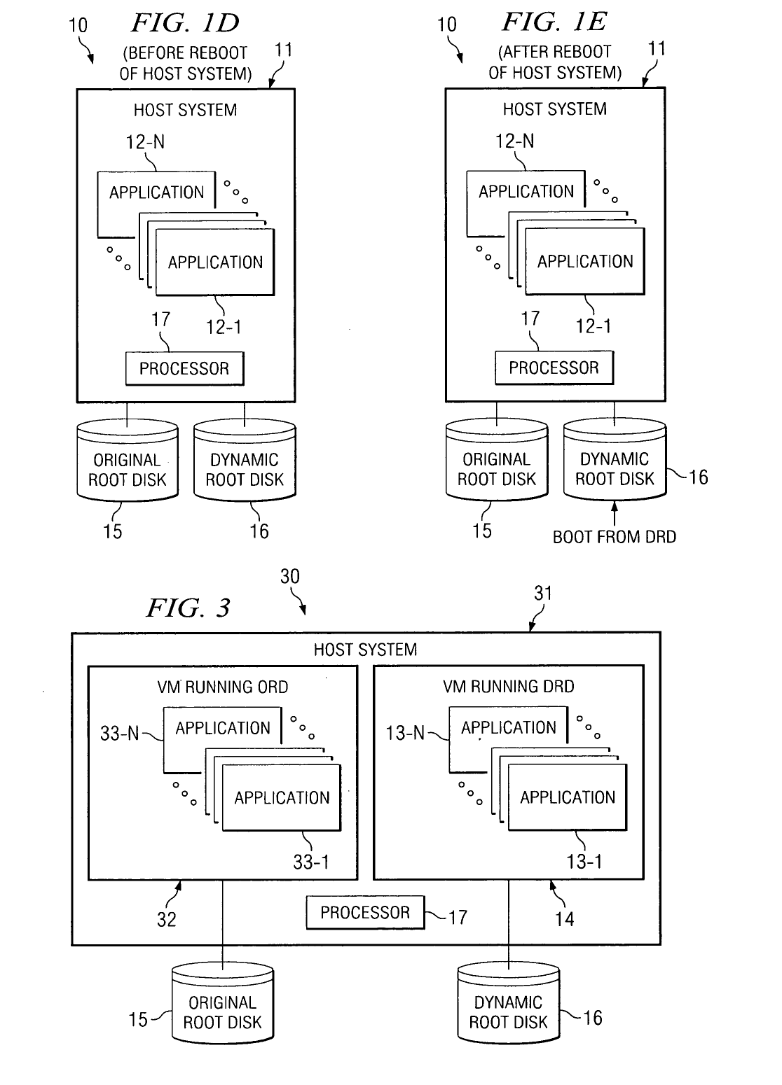

FIG. 2 shows one embodiment 20 of a method for controlling the illustrative embodiments shown in FIGS. 1A through 1E. Process 201 clones the original root disk (FIG. 1A, image 15) of the host system's booted system environment (BSE) 11 in order to create dynamic root disk (DRD) 16. Process 202 creates a virtual machine to be run within the host system's BSE 11, to be booted from DRD 16. Process 202 transfers ownership of DRD 16 to VM 14, making whatever “personality changes” are deemed necessary. Process 203 controls the booting of VM 14 from DRD 16.

Process 204 modifies the system resources in VM 14 which are stored on DRD 16. These resources, for example, are the file system and the kernel and are modified or updated as desired.

Process 205 determines if a reboot is necessary. If it is, the reboot is performed via process 206.

Process 207 determines if further modifications are necessary. If they are, they are made via process 204 and processes 204, 205, 206, and 207 continue until there are no further reboots or no further modifications.

Process 208 then tests the updated versions or the added resources and process 209 then determines if the test is satisfactory. If it is not, then process 210 controls the necessary corrections and again processes 205, 206, 207, 208 and 209 determine if the update has been satisfactorily fixed.

When the update is deemed okay for general use (i.e. process 209 determines that the test was satisfactory), process 211 begins to merge the updated system back into the original system by shutting down VM 14 and transferring ownership of DRD 16 to the host system (again making whatever “personality changes” are deemed necessary). Process 212 will shutdown all of the applications on host system 11. Process 213 reboots host system 11 from the DRD. During this reboot process, the host system BSE 11 becomes based upon the updates stored on DRD 16. Process 214 then starts all applications on the updated host system BSE and the merge is complete.

Note that while a VM has been shown running within a host system's BSE, the concepts discussed can be applied to situations where the VM is not running within the host system to update. Thus, any system (physical or virtual) can have its root disk cloned to an DRD. A VM (hosted anywhere that can access the DRD) can boot off the DRD, and perform all of the updating steps. Once done, the VM can shutdown, and the original system booted from the DRD being updated with only one reboot. In addition, since some administrators “update” their system by re-installing the OS (i.e. from scratch), a VM can install an OS from scratch. The VM is used to perform whatever level of customization is desired, and then the root disk is converted into another system's DRD, the VM is shutdown, the other system boots from the DRD, and is updated with only one reboot.

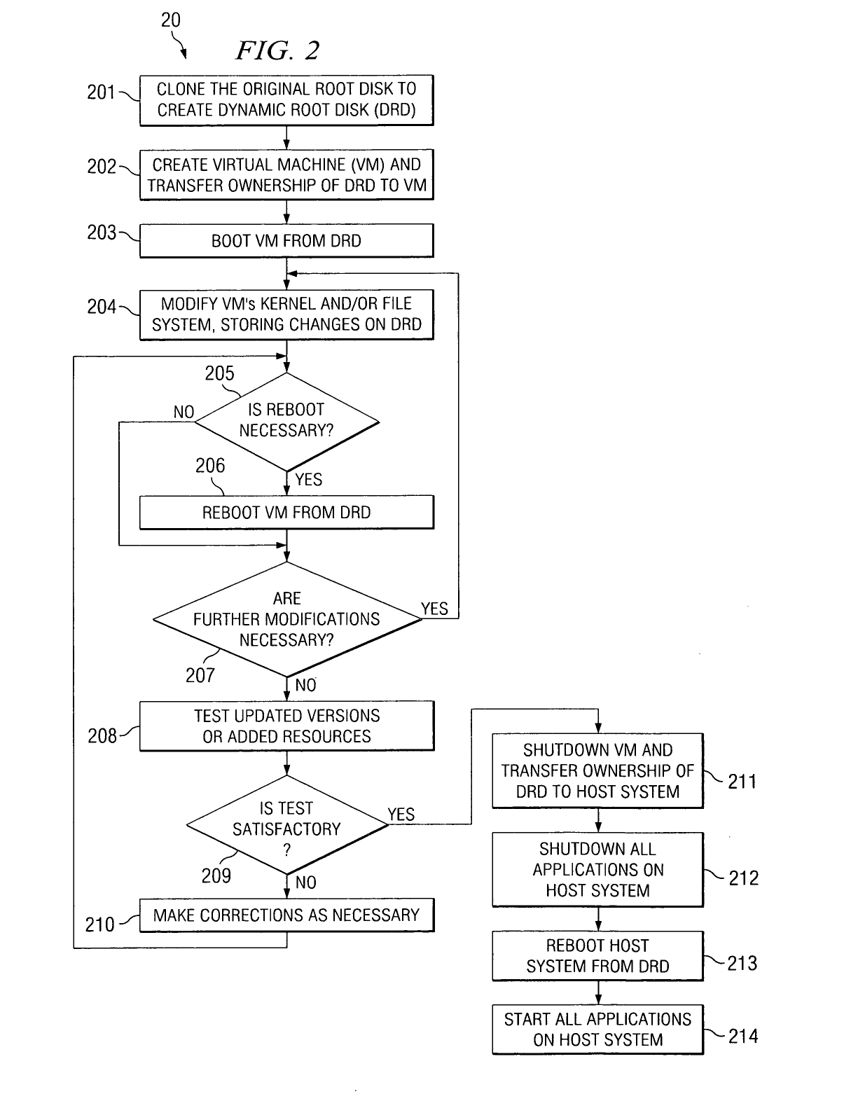

FIG. 3 shows one embodiment 30 having host system 31. Original VM 32 having applications 33-1 to 33-N running therein is booted on host system 31 from original root disk 15 while VM 14, also booted on host system 31, is, as discussed above, booted from DRD 16. Once all of the changes/updates are made to DRD 16 (as discussed above) original VM 32 is booted from DRD 16 instead of from ORD 15.

In addition, the VM does not have to be on the same system as the system running the ORD, as long as the bootable image is accessible to another system. One example would be in a SAN boot environment or in any shared disk image. Using this approach the ORD can be cloned and the DRD booted on a different system. When the updates are complete, the VM is shut down and the original system is rebooted on the updated boot image.

While the discuss herein is focused on reducing reboots, there are other benefits to running the DRD in a VM. For example, no matter what changes are made, the running system is not “broken”. This could include things such as kernel tunables, shared libraries, restarting of shared processes/services, etc.

What is claimed is:

1. A method for updating a computer system, said method comprising:
creating on said computer system a dynamic root disk (DRD);
identically copying to said DRD at least a portion of said system's current root disk;
creating on said computer system a virtual machine (VM) system that runs within the booted system environment (BSE) of said computer system and boots from said DRD; and
updating said VM and DRD, said updating comprising rebooting said VM any number of times as required for proper updating and testing without affecting said BSE running on said computer system outside of said VM and DRD.

2. The method of claim 1 further comprising:
after said DRD is properly updated allowing applications to run on said updated VM.

3. The method of claim 1 further comprising:
rebooting said BSE from said updated DRD.

4. The method of claim 3 further comprising:
after said BSE is rebooted from said updated DRD causing said applications to run on said rebooted BSE.

5. The method of claim 1 wherein said updating is selected from the list of:
adjusting kernel tunables, updating shared libraries, restarting of shared processes;
restarting of shared services.

6. A computer system comprising:
a processor having created thereon a production system in which at least one application can be run;
said processor operable for creating a clone of said production system and for booting said clone from a dynamic root disk (DRD);
said processor further operable for:
updating any portion of said cloned production system, said updating not affecting said production system; and
rebooting said cloned production system from said DRD any number of times without rebooting said production system.

7. The system of claim 6 wherein said processor is further operable for:
testing said updated cloned production system separately from testing said production system.

8. The system of claim 6 wherein said processor is further operable for:
merging said updated cloned production system back into said production system.

9. The system of claim 8 wherein said processor is further operable for:
rebooting said production system from said DRD after said merging such that said updates are present on said production system after said rebooting.

10. A method for updating computer elements, said method comprising:
creating on a host machine a dynamic root disk (DRD) from an original root disk (ORD);
establishing a computing environment by booting from said DRD, said computing environment separate from a computing environment created on said host machine; and
updating elements of said created separate computer environment, said updating including, if necessary, rebooting said DRD any number of times as required for proper updating and testing without affecting any application running on a computer environment booted from said ORD.

11. The method of claim 10 further comprising:
establishing a host computing environment by booting from said DRD after said computer elements are updated on said DRD.

12. The method of claim 10 wherein said DRD established computer environment is on a system separate from a system booted from said ORD.

13. The method of claim 10 wherein said DRD established computer environment is a virtual machine running on a system booted from said ORD.

14. The method of claim 10 wherein said DRD established computer environment is a virtual machine running on a computing system different from the computing system booted by said ORD.

15. A method for modifying any portion of a computing platform said method comprising:
creating a completely isolated computing platform booted from a dynamic root disk (DRD) which is a copy of an original root disk (ORD) used to boot a first platform of said computing platform, said isolated platform being an exact duplicate of the computing platform booted from said ORD;
performing modifications of resources on said created isolated platform without affecting resources running on said ORD booted computer platform, said modifications comprising modifications to said DRD; and
rebooting said first platform of said computing environment using said modified DRD.

16. The method of claim 15 wherein said rebooting comprises:
removing the isolation between said computing environments.

17. The method of claim 16 wherein said creating comprises:
cloning said ORD to form said DRD; and
creating a virtual machine (VM) to run computing environments booted from said DRD.

18. The method of claim 17 further comprising:
running at least one application on said VM for testing of any modifications to resources of said DRD.

19. The method of claim 15 wherein said ORD booted first computer platform is a VM created on a host system, said host system supporting both said VM and said isolated computing platform booted from said DRD.

20. A computer readable medium for controlling a computing system, said medium containing computer-readable code, said medium comprising:
code for creating a clone of an operating system upon which applications can be run;
code for creating a booted system environment (BSE) using said operating system clone; and
code for controlling changes to resources on said BSE, said changes including allowing said cloned operating system to be rebooted any number of times without affecting resources concurrently running on said operating system.

21. The medium of claim 20 further comprising:
code for determining when said changed BSE is stable; and
code for creating a new booted system environment to replace the booted system environment created from said operating system, said new booted system environment booted from said operating system clone.

22. The medium of claim 21 further comprising:
code for merging said cloned operating system into said operating system.

23. The medium of claim 21 wherein said determining code comprises:
code for running applications on said BSE created from said operating system clone.
